(19) United States
(12) Patent Application Publication
(10) Pub. No.: US 2003/0021953 A1
(43) Pub. Date: Jan. 30, 2003

(54) Absorbent creped paper sheet comprising a background pattern and a main decorative pattern, and embossing roll and method for making such a sheet

(76) Inventor: Pierre Graff, Wolfgantzen (FR)

Correspondence Address: YOUNG & THOMPSON, 745 SOUTH 23RD STREET 2ND FLOOR, ARLINGTON, VA, 22202

(21) Appl. No.: 10/181,977

(22) PCT Filed: Nov. 15, 2001
(86) PCT No.: PCT/FR01/03583

(30) Foreign Application Priority Data
Nov. 24, 2000 (EP) 00 403 285.0

(51) Int. Cl. B29C 59/04; B32B 3/00

(52) U.S. Cl. 428/153; 425/363; 425/385; 428/156

(57) ABSTRACT

The invention provides an embossed sheet (10) consisting of at least one ply of crêped cellulose wadding with a grammage of between 12 and 30 g/m2 of the type with an embossed pattern (16, 18) comprising at least a first series of protuberances (16) formed so as to project from one face of the ply (14) and the density of which is greater than 20e protuberances per cm2, characterized in that each protuberance (16) of the first series comprises a truncated polyhedron-shaped base (28) and a flattened free-end portion (30) with rounded edges.

The invention relates to a sheet of paper, in particular a sheet of absorbent paper made of crêped cellulose wadding, comprising an embossed pattern.

In particular, the invention relates to a sheet of paper, especially constructed from at least one ply of absorbent paper made of crêped cellulose wadding, intended for the field of wiping for household, domestic or industrial use, that is to say capable of being used as a paper towel, cloth, etc.

In the field of papers for sanitary or domestic use, such as toilet paper or paper towel, it is known to produce paper sheets consisting of several plies of absorbent paper, for example made of crêped cellulose wadding, also called tissue paper, with a grammage of between 12 and 30 g/m2, endowed with protuberances which are obtained by embossing.

This is because the embossing gives fullness to the sheet and it leads to improved liquid absorption, touch and softness. It is sought to further increase the absorbency by creating multilayer sheets obtained from combining at least two layers, also called plies, each consisting of at least one of said embossed sheets.

Two methods of embossing and assembling plies are commonly used depending on the features required for the final product.

The first is known in the field as the “nested” method. It consists, first of all, in embossing each of the plies separately so as to form protuberances which are generally substantially frustoconical or in the shape of truncated pyramids, on the surface. Next, adhesive is deposited on the apex of the protuberances of one of the plies, and the plies are arranged so that the faces having the protuberances are opposite each other, the protuberances of one between the protuberances of the other.

Finally, the plies are assembled such that the protuberances which have been coated with adhesive rest between the protuberances of the other ply. Thus the two plies are joined by spots of adhesive between the apexes of the protuberances of one ply and unembossed regions between the protuberances of the other ply. A structure is produced where the spaces made in this way are suitable to provide the sheet with improved absorption. Furthermore, the outer faces have a smooth and soft touch because of the hollow regions formed by the back of the protuberances. This technique is illustrated by patent U.S. Pat. No. 3,867,225.

The second assembly method is known in the field as the tip-to-tip method. It is distinguished from the previous method by the relative arrangement of the two plies. The latter, after they have been separately embossed, are brought one over the other so that the apexes of the protuberances are made to coincide.

The plies are joined together by the apexes of the protuberances, tip against tip. This technique is illustrated by patent U.S. Pat. No. 3,414,459.

When considering the practical production of these structures, whether they are of the nested or tip-to-tip type, the protuberances obtained during the embossing are most often made so as to be distributed in a pattern.

In general, several types of patterns and/or combination of patterns are known.

In order to provide tissue paper having a textile appearance, it has already been proposed to produce a background pattern said to have a high density of protuberances.

One example of such a product is described and shown in patent EP-B1-0 426 548.

According to the various known embodiments of such a type of paper with a background pattern having a high protuberance density, each of these protuberances has a generally frustoconical shape, each truncated cone being formed by an equivalent peg belonging to an embossing roll. Each peg etched on the roll has an angle at the apex less then or equal to 60° endowing it with an overall pointed shape.

The height of the pegs is, for example, between 0.4 mm and 0.6 mm, the choice of this total height being a compromise depending on the density of the pegs which is an inverse function of the peg height.

Decorative patterns consisting of series of protuberances which are arranged at least in part in curves, portions of curves or straight lines, or else combinations of such portions of curves and/or straight lines, have also been proposed for the purpose especially of improving the appearance of the product. In particular, some of said portions are, at least partially, parallel to each other. In particular, the protuberances form closed curves comprising circles or portions of circles which may be concentric.

Document WO-A-93/12293 proposes combining the two types of patterns.

Thus, in that document, a complex sheet comprising the combination of two plies, at least one of the plies of which comprises a high-density background pattern with small dimensions of the protuberances, also called “microembossing” and a main decorative pattern consisting of series of protuberances of larger dimensions, and especially of greater height, also called “macroembossing”, is provided.

The macroprotuberances constituting the main decorative pattern have a density less than 20 protuberances per cm2 and are combined with the microprotuberances of the background pattern which have a density greater than 30 per cm2 and preferably greater than or equal to 40 per cm2.

Depending on the embossing conditions, such as the pressure and the type of etched backup roll (rubber or rigid), products are made with macroprotuberances, for example with a height of between 0.5 and 2.5 millimeters, and microprotuberances with a height of between 0.1 and 0.3 mm. These heights correspond to those which can be measured on the ply after its embossing, and not to the height of the pegs of the etched embossing roll.

The embossing, by increasing the overall thickness of the sheet, leads to an improvement in the absorption of liquids, and also in its flexibility because of the rupture of some of the bonds between the cellulose wadding fibers. Thus, the embossing generally leads to a loss in the tear strength.

For products intended for wiping and made of crêped tissue paper of the CWP (conventional wet pressed) type, the sheet may contain additives which give it an increased tear strength, especially in the moist state.

For toilet paper, the embossing is additionally more marked since it is desired to obtain a higher absorbency.

The invention aims to provide an improved design of an embossed sheet comprising at least one ply with a background pattern having microprotuberances and especially, but not only, making it possible to combine it with a pattern having macroprotuberances.

The invention aims to improve the performance and technical features of the sheet in the case of a combination of microprotuberances and of macroprotuberances, and to improve the final appearance of the sheet by better highlighting the pattern having macroprotuberances which, according to the prior art, is “embedded” into the background pattern and is greatly “flattened” which also prevents the relief and the quilted effect from being achieved.

With this aim, the invention provides an embossed sheet consisting of at least one ply of crêped cellulose wadding with a grammage of between 12 and 30 g/m2 of the type with an embossed pattern comprising at least a first series of protuberances formed so as to project from one face of the ply and the density of which is greater than 20 protuberances per cm2, characterized in that each protuberance of the first series comprises a truncated polyhedron-shaped base and a flattened free-end portion with rounded edges.

According to other features of the sheet:

the base is a truncated polyhedron;

the base is a truncated pyramid;

the base is a regular truncated pyramid with a rectangular baseplate;

each side face of the base forms an angle, with respect to the height of the truncated pyramid, which is between 30° and 45°, preferably between 35° and 45°;

the free-end portion of the protuberance comprises a central region which is substantially flat and parallel to the general plane of the sheet and which is connected to the side faces of the base by connection regions with a rounded profile;

the total height of the protuberances is between 0.05 mm and 0.5 mm;

the density of the protuberances is between 30 and 80 per cm2;

the protuberances of the first series belong to a background pattern, and in that said at least one ply comprises a second series of protuberances, combined with the first series in order to constitute a main pattern, in particular a decorative pattern, the height in relief of which is greater than the height of the protuberances of the first series;

the sheet is an absorbent multi-ply sheet with at least two plies of cellulose wadding, characterized in that it comprises at least one ply constructed according to the invention, said protuberances being turned toward the inside of the sheet;

the main pattern is formed from alignments of protuberances, the protuberances of the background pattern being arranged between said alignments.

The invention also provides an engraved roll for embossing said at least one ply belonging to a sheet embossed according to the invention, of the type comprising a series of pegs in order to form the protuberances belonging to said first series, characterized in that each peg comprises a truncated polyhedron-shaped base and a flattened free-end portion.

According to other features of the roll:

the base is a truncated polyhedron;

the base is a truncated pyramid;

each side face of the base forms an angle, with respect to the height of the truncated pyramid, which is between 30° and 45°;

the total height of each peg is between 0.4 and 0.6 mm;

the base is a regular truncated pyramid with a rectangular baseplate the width of which is parallel to the machine direction of the roll;

the base is a regular truncated pyramid with a rectangular baseplate the width of which is parallel to the cross direction of the roll;

the free-end portion of the peg comprises a substantially flat central region which is connected to the side faces of the base by connection regions with a rounded profile.

The invention also provides a method of manufacturing a sheet according to the invention, characterized in that it consists in embossing a first ply of cellulose wadding on an engraved roll in the background pattern according to the invention, so as to increase its thickness by less than 50%, then next in embossing said ply in said main pattern. Said ply may be combined with at least one second ply which may be pre-embossed.

Other features and advantages of the invention will become apparent on reading the detailed description which follows, for the understanding of which reference may be made to the appended drawings, in which:

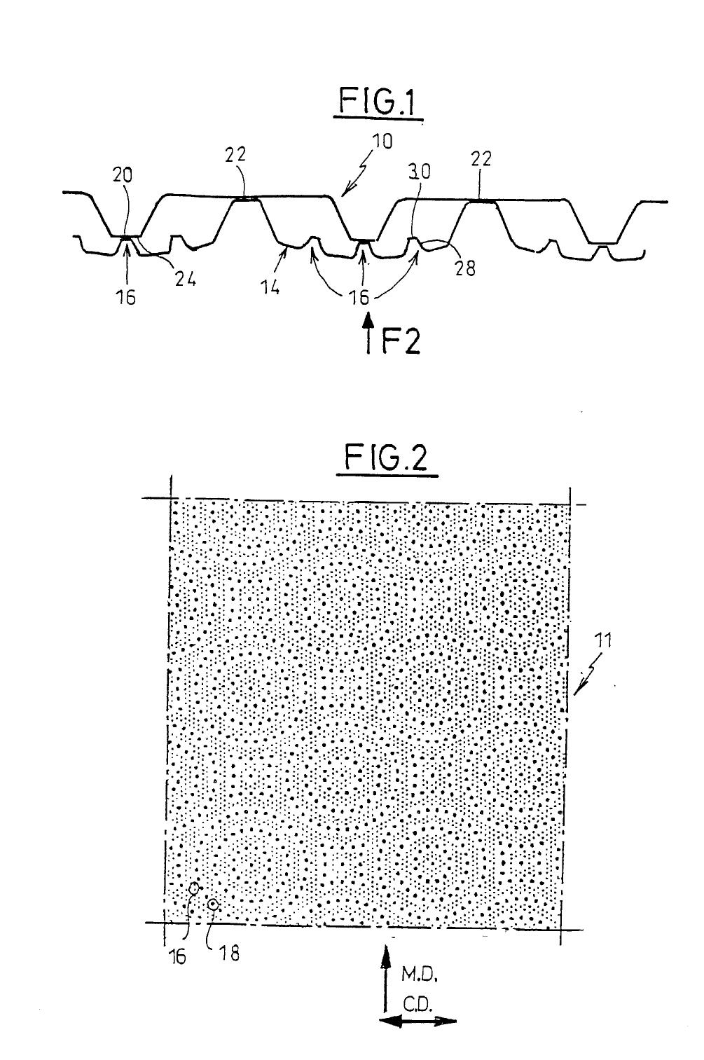

FIG. 1 is a view in cross section through a vertical plane in the machine direction, which shows schematically an embossed sheet with two plies, the lower ply of which comprises the combination of a background pattern and of a main pattern;

FIG. 2 is a detailed view along the arrow F2 of FIG. 1 which illustrates the combination of the background pattern with one example of a main pattern;

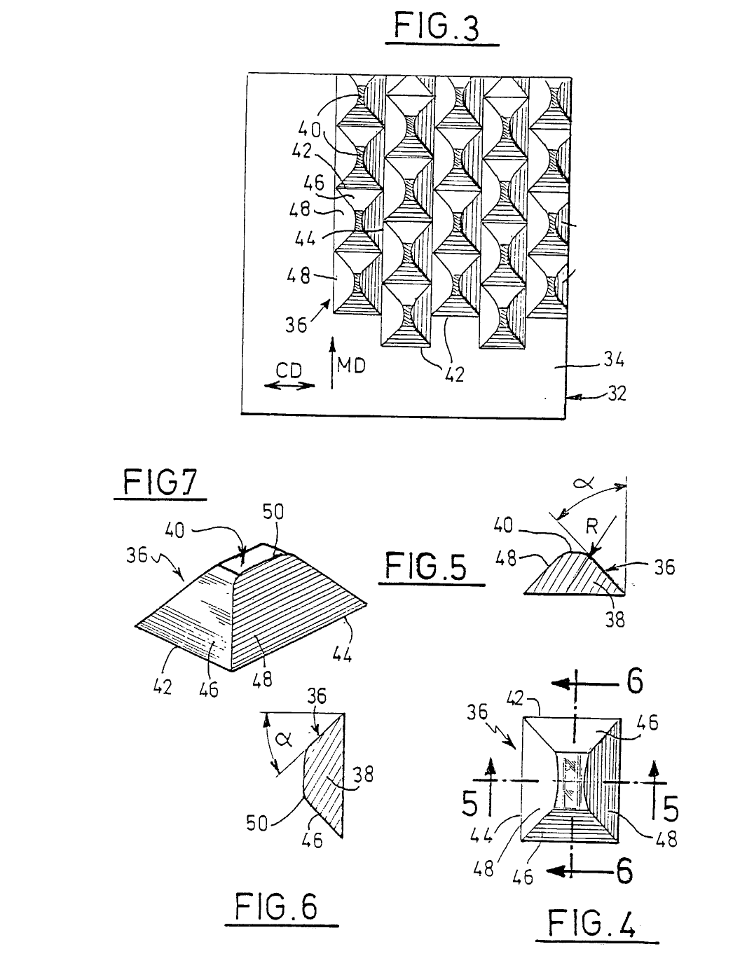

FIG. 3 is a developed view of part of the etched surface of an embossing roll according to the teachings of the invention;

FIG. 4 is a larger-scale detailed view of one of the pegs of FIG. 3;

FIGS. 5 and 6 are views in cross section along lines 5-5 and 6-6 of FIG. 4;

FIG. 7 is a perspective view of the peg shown in FIGS. 4 to 6;

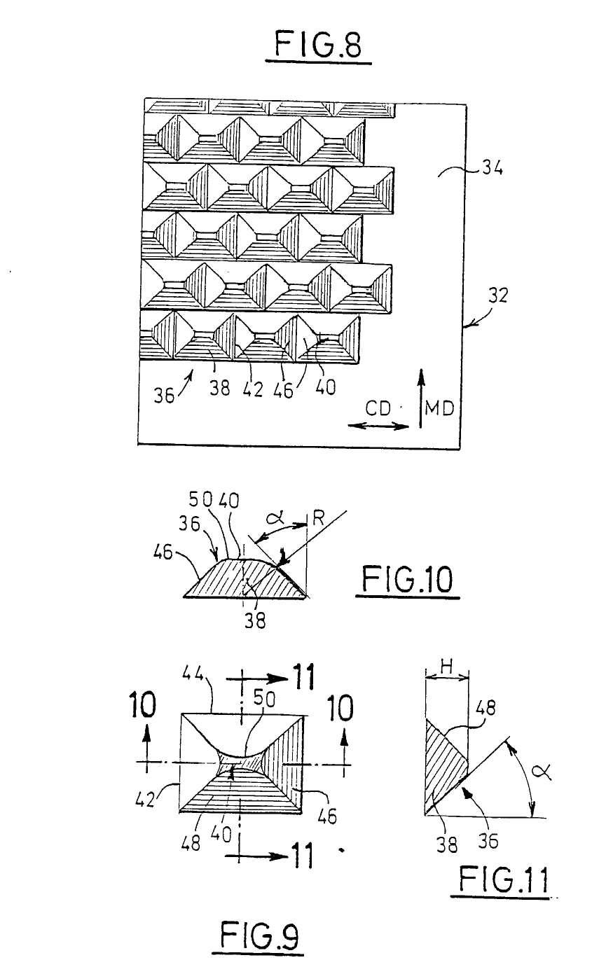

FIGS. 8 to 11 are views similar to those of FIGS. 3 to 6 which illustrate a second embodiment of an etched roll according to the teachings of the invention for producing the background pattern;

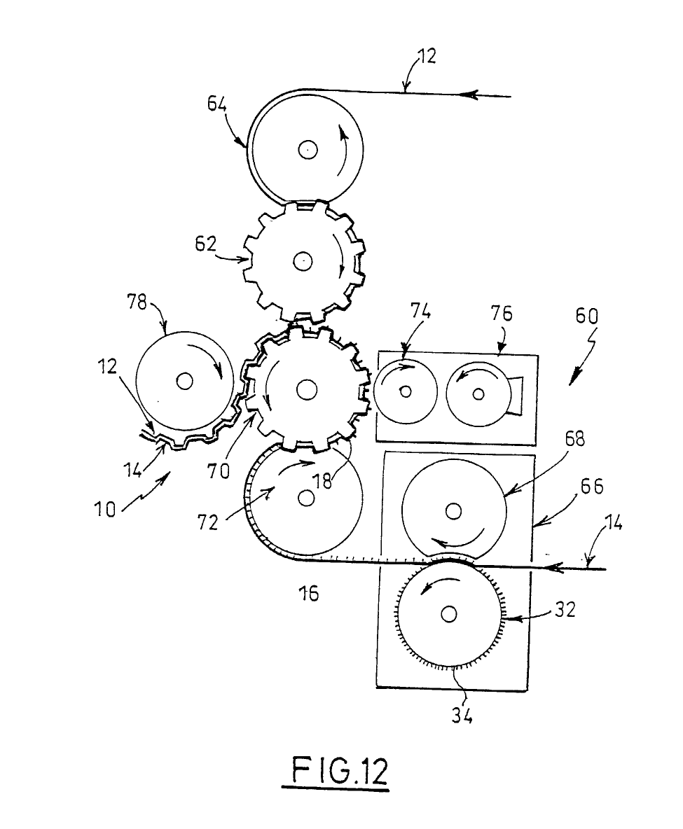

FIG. 12 is a schematic view illustrating a machine for producing a complex sheet produced according to the teachings of the invention.

In the following description, elements which are identical, similar or the like will be denoted by the same reference numbers. A vertical upward orientation will be used, especially when considering FIG. 1, by way of nonlimiting example and to facilitate the description and the understanding of the claims.

FIG. 1 shows an exemplary embodiment of a complex sheet of embossed paper, which in this case is a sheet of paper consisting of two plies, the upper 12 and lower 14 plies, which are combined according to the technique known in the art as “nested”.

Each ply of absorbent paper is made of crêped cellulose wadding and the sheet 10 is intended for all types of hygiene or household products.

The cellulose wadding, whose grammage is between 12 and 30 g/m2, is preferably of the type obtained by conventional wet pressing, called CWP.

More particularly, the sheet of paper shown in FIG. 1 is, for example, intended to be incorporated into a roll of paper towel.

The lower ply 14 is a ply made according to the teachings of the invention and, in this embodiment, it comprises a background pattern consisting of microprotuberances 16 and a main pattern, consisting of a series of macroprotuberances 18.

As can be seen in FIG. 2, the design and the density of the microprotuberances 14, arranged in a regular pattern, endows the bottom of the ply 14 with a textile appearance, while in this case, the macroprotuberances 18 are arranged in a regular pattern, especially in the form of concentric circles. It is observed that the background pattern is arranged between the alignments forming the main pattern. In particular, the background pattern fills the region between two concentric circles. The space between two adjacent macroprotuberances along alignments forming the circles does not have visible microprotuberances of the background pattern.

The number of macroprotuberances is less than 20 per cm2. This allows the plies to be combined in the “nested” mode. In this case, it is preferably between 5 and 15 per cm2, and more particularly between 5 and 9.

As will be explained below, the connection between the upper ply 12 and the lower ply 14 is preferably obtained by gluing apexes 22 of the macroprotuberances 18 with opposing parts 24 and 26 of the inner, in this case lower, face of the upper ply 12.

According to the teachings of the invention, each protuberance 16 of the background pattern of the lower ply 14 comprises a truncated polyhedron-shaped base 28 and a flattened free-end portion 30 with rounded edges.

According to a known technique, the microprotuberances 16 are obtained by embossing the lower ply 14 by means of an etched embossing roll 32, part of the outer convex cylindrical surface 34 of which is illustrated schematically, especially in FIG. 3.

As can be seen in FIG. 3, the surface 34 comprises a series of pegs 36 formed in relief and the external shape or profile of which is the equivalent of that which it is desired to obtain for each corresponding protuberance 16 of the ply 14 of the sheet 10.

In FIG. 3, the machine direction of the roll, that is to say the direction of movement of its surface when it is rotating during the embossing operation, has been indicated by an arrow MD, and the cross direction, which corresponds to the direction perpendicular to the machine direction MD and parallel to the axis of rotation of the etched roll 32, has been indicated by an arrow CD.

In the embodiment illustrated in FIG. 3, the entire etched surface 34 of the roll 32 is covered with pegs 36 which are mutually adjacent and which, in the example shown, all have the same shape and the same dimensions. Insofar as they come within the scope of the invention, pegs of different shapes may be provided.

In this case, each peg 36 consists of a base 38 in the shape of a truncated pyramid with a rectangular baseplate and of an apex or free-end portion 40 which is flattened.

The rectangular baseplate of each peg 36 is delimited by two small sides 42 or widths 42, which in this case are parallel to the cross direction CD, and by two large sides 44 (or lengths 44), which in this case are parallel to the machine direction MD.

Each peg 36 is delimited laterally by two small substantially trapezoidal opposed faces 46, whose baseplate is a small side 42, and by two large substantially trapezoidal opposed faces 48, whose baseplate is a large side 44.

As can be seen, especially in FIGS. 5 and 6, each substantially trapezoidal lateral face 46, 48 is inclined with respect to the height, or central axis A, of the peg 36, by an angle alpha which, in this case, is equal to about 45°, that is to say that the half-angle at the apex of the truncated pyramid-shaped base 38 is in this case equal to 45°.

The free-end portion, or apex 40, is overall a flat surface which is substantially plane and perpendicular to the central axis A and it is preferably connected to the triangular lateral faces 46 and 48 by rounded edges 50.

In the embodiment shown in FIGS. 3 to 7, the total height H of each peg 36 is about 0.6 mm while the width 42 of its rectangular baseplate is 1.4 mm and the length 44 is 1.8 mm.

The width of its apex 40, which is of generally rectangular shape in top view and, as can be seen in FIG. 4, is equal to about 0.2 mm while the length of the apex 40 is equal to about 0.6 mm.

As can be seen in FIG. 3, all the pegs 36 are adjacent and are formed on the surface 34 in the form of series of pegs aligned along the machine direction MD.

All the pegs 36 of the same series are thus mutually adjacent at their widths 42 and they are adjacent to the pegs of the following line at their lengths 44.

Furthermore, as can be seen in FIG. 3, the pegs 36 of a series are offset in the machine direction, that is to say in this case parallel to their length 44, by a half pitch, that is to say by half of the length 44 of the rectangular baseplate of a peg 36, in this case 1.8 mm, two apexes 40 of two consecutive aligned pegs belonging to the same series, of course, being spaced apart by 1.8 mm.

If reference is made to the abovementioned dimensions, the density of the pegs 36 is substantially equal to 40 pegs per cm2.

It is of course possible to reduce the total height of each peg 36, depending on the application, and to increase, in an inversely proportional manner, the density of the pegs.

The inclination of the lateral faces 46 and 48 may be increased, by reducing the value of the angle alpha to 30°, this limiting value remaining greater than the value of the half-angle at the apex of a conventional, markedly more pointed, frustoconical-shaped peg. Preferably, the angle remains between 35° and 45°. The edges of the flat surface are rounded.

The radius R of each rounded edge, or fillet 50, is for example in this case equal to 0.5 mm. In the embodiment shown in FIGS. 8 to 11, the shape and the dimensions of each peg 36 are overall identical to those mentioned above with reference to the first embodiment, but the pegs, as can be seen in FIG. 8, are aligned in a series of pegs which are adjacent at their width 42, in the cross direction CD of the etched roll 32.

Without departing from the scope of the invention, the dimensions of the apex or free end 40 may be larger.

Thus, each apex, or free end, may be a rectangular flat surface, the width of which is 0.4 mm and the length 0.8 mm, the radius R of each rounded edge 50 in this case being substantially equal to 0.1 mm, while the height H and the other dimensions of the widths 42 and lengths 44 are unchanged.

The embossing of the background pattern, that is to say, the production of the microprotuberances 16 using one of the etched rolls of the type shown in FIGS. 3 to 11, is achieved with moderate embossing pressure, that is to say by controlling the increase in the total thickness of the ply 14 resulting from the embossing.

This increase is preferably less than or equal to the initial thickness of the ply 14, that is to say of the sheet of crêped cellulose wadding before embossing.

Preferably, this height increase is less than half the thickness of the sheet.

After this step of embossing with a moderate pressure, the lower ply 14 comprises pegs 16, the height of which is between 0.05 mm and 0.5 mm. As will be explained below, the ply which has just been embossed in order to produce the background pattern with the microprotuberances 16 is then embossed again in order to produce the main pattern consisting of the macroprotuberances in concentric circles 18.

The embossing pressure is then enough to allow the formation of convex annular regions between the concentric circles.

FIG. 12 shows schematically a plant 60 for embossing and assembling by adhesively coating the two upper 12 and lower 14 plies, for the purpose of producing the complex sheet 10.

In a known manner, the sheet of crêped cellulose wadding forming the ply 12 passes first of all between a first etched roll 62 and an associated roll 64 for producing the embossed pattern of this ply 12. The roll 64 may have a rubber or similar coating, or else a rigid coating such as steel or paper, but it is then provided with cavities which complement the protuberances of the etched roll 62.

In the same way, the sheet of cellulose wadding constituting the lower ply 14 passes first of all through a microembossing unit 66 comprising the etched roll 32 whose etched convex cylindrical surface 34 complies with the teachings of the invention and which engages with an associated roll 68 for producing the background pattern comprising the microprotuberances 16. Preferably, the roll 68 is made of rubber.

The ply 14, with its microembossing 16, then passes between a third etched roll 70, the etching pattern of which corresponds to the formation of macroprotuberances in concentric circles 18 and which engages with an associated rubber roll 72.

The lower ply 14, with its microembossing 16 and its macroembossing 18, then passes opposite the upper etched roll 62 to enable the combination of the two plies, while being passed beforehand in front of an adhesive-coating roll 74 belonging to an adhesive-coating unit 76, of a known design, which deposits adhesive on the apexes which are highest with respect to the roll 70. This involves macroprotuberances 18.

Finally, the two plies 12 and 14 pass in front of a roll 78, called a matching roll, which will ensure the combination in a close-fitting manner.

The visual appearance obtained for the ply comprising the microembossed background pattern and the macroembossed main decorative pattern is markedly improved compared to a product of the prior art, without the background pattern.

In particular, the method has been applied to a main pattern consisting of protuberances forming concentric circles. As is shown in FIG. 2, the background pattern occupies the space between the concentric circles and other elements. However, the space between two adjacent protuberances on the circles themselves is not large enough to house a microprotuberance. In this condition and the conditions of the method, a product whose surface seen from the background pattern side has the appearance of rings in concentric relief forming toroidal cushions.

Furthermore, tests have been carried out which surprisingly show that the tear strength of such a product is not less than that of a product without this background pattern.

The results of these tests are summarized in the table below.

The first row gives the values of an unembossed two-ply sheet. This provides reference values. The measurements were carried out according to the usual standards in this field.

The second row gives the values of a product A of the prior art, the two plies of which have been embossed only with the main pattern. This is a paper towel marketed under the brand “Okay” in France and having a pattern consisting of concentric circles as in FIG. 2, but without the background pattern. There is an average of 7.6 macroprotuberances per cm2.

The third row gives the values of a product B made according to the invention, that is to say with the same main embossed pattern as the product A above and the same embossing conditions, but with an additional background pattern according to the invention, distributed as in FIG. 2, and comprising 40 microprotuberances per cm2.

It is noted that the losses in strength compared to the reference value are of the same order, while a greater drop in strength would have been expected because of the additional treatment for producing the background pattern.

| | | | Extension | | |
|---|---|---|---|---|---|
| | | Dry | Machine direction | Wet | Afrior absorption |
| | | strength | MD | strength | cm³/g |
| | Thickness | N/m/2 plies | (dry) | N/m/2 plies | Tolerance |
| | mm | MD : CD | % | CD | compared to |
| | Tolerance | Tolerance | Tolerance | Tolerance | reference paper |
| 2 unembossed plies | 0.18 | 844:636 | 23 | 146 | 5.0 |
| (44.8 g/m²) | | | | | |
| 2 embossed plies | 0.91 | 632:308 | 23 | 78 | 9.2 |
| prior art | | −25%:−52% | | −46% | +84% |
| (44.6 g/m²) | | | | | |
| 2 embossed plies | 0.91 | 640:299 | 22 | 75 | 9.3 |
| invention | | −24%:−53% | | −18% | +86% |
| (44.3 g/m²) | | | | | |

In addition, another series of tests was carried out to verify the efficiency of liquid diffusion. The test consisted in measuring the diffusion time of an aqueous liquid in the machine direction MD and cross direction CD of the sheet of invention B with respect to a product of the prior art A. The table below summarizes the diffusion values in seconds over distances measured in cm, both in the MD direction and CD direction.

| | MD direction; diffusion time for a | | | | | | | | CD direction; diffusion time for a distance | | | | | | | |
|---|---|---|---|---|---|---|---|---|---|---|---|---|---|---|---|---|
| | distance of 8 cm | | | | | | | | of 8 cm | | | | | | | |
| cm | 1 | 2 | 3 | 4 | 5 | 6 | 7 | 8 | 1 | 2 | 3 | 4 | 5 | 6 | 7 | 8 |
| A | 0.7 | 2.3 | 5 | 9 | 14 | 20 | 37 | 49 | 0.4 | 1.7 | 3.7 | 6.2 | 9 | 14 | 24 | 32 |
| B | 0.6 | 2.1 | 5 | 9 | 14 | 19 | 35 | 44 | 0.8 | 2.2 | 4.0 | 7 | 10 | 15 | 26 | 33 |

The results show that the product B according to the invention has a better distributed diffusion, in the machine direction and in the cross direction.

Comparative tests were carried out.

Three products were produced from the same tissue paper having the following properties:

Grammage, two plies: 45 G/m2

Thickness: 0.20 mm for a two-ply sheet

Strength, MD: 786 N/m, CD: 538 N/m

Wet strength: CD 136 N/m.

Firstly the wet strength in the cross direction of a product having background embossing consisting of microprotuberances obtained on a roll whose pegs are of frustoconical shape with an apex angle slightly less than 30° was measured. The density of the pegs of the background pattern was 37 per cm2.

The wet strength in the cross direction of a product A with the pattern of the prior art (7.6 macroprotuberances per cm2) was measured.

The wet strength of a product B made according to the invention was measured.

The values were 77, 67 and 75 N/m, respectively. It was therefore noted that the invention makes it possible to produce a product with a main pattern and a background pattern without detriment to its strength.

Finally, it was noted that, for the same starting tissue paper and with equal strength and thickness, a sheet according to the invention is less rigid than a sheet with a single main embossed pattern. The rigidity may be estimated by means of a test panel of consumers or else using a model based on measurements of suitable physical parameters.

1. An embossed sheet (10) consisting of at least one ply of crêped cellulose wadding with a grammage of between 12 and 30 g/m2 of the type with an embossed pattern (16, 18) comprising at least a first series of protuberances (16) formed so as to project from one face of the ply (14) and the density of which is greater than 20 protuberances per cm2, characterized in that each protuberance (16) of the first series comprises a truncated polyhedron-shaped base (28) and a flattened free-end portion (30) with rounded edges.

2. The sheet as claimed in claim 1, characterized in that the base (28) is a truncated polyhedron.

3. The sheet as claimed in claim 2, characterized in that the base (28) is a truncated pyramid.

4. The sheet as claimed in claim 3, characterized in that the base (28) is a regular truncated pyramid with a rectangular baseplate.

5. The sheet as claimed in either of claims 3 and 4, characterized in that each side face of the base (28) forms an angle, with respect to the height of the truncated pyramid, which is between 30° and 45°, preferably between 35° and 45°.

6. The sheet as claimed in the preceding claim, characterized in that the free-end portion (30) of the protuberance (16) comprises a central region which is substantially flat and parallel to the general plane of the sheet (14) and which is connected to the side faces of the base by connection regions with a rounded profile.

7. The sheet as claimed in any one of the preceding claims, characterized in that the total height of the protuberances (16) is between 0.05 mm and 0.5 mm.

8. The sheet as claimed in any one of the preceding claims, characterized in that the density of the protuberances (16) is between 30 and 80 per cm2.

9. The sheet as claimed in any one of the preceding claims, characterized in that the protuberances (16) of the first series belong to a background pattern, and in that said at least one ply (14) comprises a second series of protuberances (18), combined with the first series in order to constitute a main pattern, in particular a decorative pattern, height in relief of which is greater than the height of the protuberances (16) of the first series.

10. An absorbent multi-ply sheet (104) with at least two plies (12, 14) of cellulose wadding, characterized in that it comprises at least one ply (14) constructed according to any one of the preceding claims, said protuberances (16, 18) being turned toward the inside of the sheet.

11. The sheet as claimed in the preceding claim, characterized in that the main pattern is formed from alignments of protuberances, the protuberances of the background pattern being arranged between said alignments.

12. An engraved roll (32) for embossing said at least one ply (14) belonging to a sheet (10) as claimed in any one of the preceding claims, comprising a series of pegs (36) in order to form the protuberances (16) belonging to said first series, characterized in that each peg (36) comprises a truncated polyhedron-shaped base (38) and a flattened free-end portion (40).

13. The roll as claimed in claim 12, characterized in that the base (38) is a truncated polyhedron.

14. The roll as claimed in claim 13, characterized in that the base (38) is a truncated pyramid.

15. The roll as claimed in either of claims 13 and 14, characterized in that each side face of the base (38) forms an angle, with respect to the height of the truncated pyramid, which is between 30° and 45°.

16. The roll as claimed in any one of claims 12 to 15, characterized in that the total height (H) of each peg (36) is between 0.4 and 0.6 mm.

17. The roll as claimed in any one of claims 12 to 16, characterized in that the base (38) is a regular truncated pyramid with a rectangular baseplate, the width of which is parallel to the machine direction (MD) of the roll (32, 34).

18. The roll as claimed in any one of claims 12 to 16, characterized in that the base (38) is a regular truncated pyramid with a rectangular baseplate, the width (42) of which is parallel to the cross direction (CD) of the roll (32, 34).

19. The roll as claimed in the preceding claim, characterized in that the free-end portion (40) of the peg (36) comprises a substantially flat central region which is connected to the side faces (46, 48) of the base (38) by connection regions (50) with a rounded profile.

20. A method of manufacturing a sheet, as claimed in one of claims 1 to 11, characterized in that it consists in embossing a first ply of cellulose wadding onto an engraved roll in the background pattern as claimed in one of claims 12 to 19, so as to increase its thickness by less than 50%, then next in embossing said ply in said main pattern.

21. The method as claimed in the preceding claim, characterized in that said ply is combined with at least a second ply. 22. The method as claimed in the preceding claim, characterized in that said second ply is pre-embossed.
